(19) United States
(12) Patent Application Publication
(10) Pub. No.: US 2018/0020228 A1
(43) Pub. Date: Jan. 18, 2018

(54) VIDEO PROCESSING SYSTEM WITH MULTIPLE SYNTAX PARSING CIRCUITS AND/OR MULTIPLE POST DECODING CIRCUITS

(71) Applicant: MEDIATEK INC., Hsin-Chu (TW)

(72) Inventors: Ming-Long Wu, Taipei City (TW); Chia-Yun Cheng, Hsinchu County (TW); Yung-Chang Chang, New Taipei City (TW)

(21) Appl. No.: 15/644,815

(22) Filed: Jul. 9, 2017

Related U.S. Application Data
(60) Provisional application No. 62/361,096, filed on Jul. 12, 2016.

(51) Int. Cl. H04N 19/44; H04N 19/91; H04N 19/70

(52) U.S. Cl. CPC H04N 19/44; H04N 19/70; H04N 19/91

(57) ABSTRACT

A video processing system includes a storage device, a demultiplexing circuit, and a syntax parser. The storage device includes a first buffer and a second buffer. The demultiplexing circuit performs a demultiplexing operation upon an input bitstream to write a video bitstream into the first buffer and write start points of bitstream segments of the video bitstream stored in the first buffer into the second buffer. Each start point is indicative of a start address of a corresponding bitstream segment stored in the first buffer. The syntax parser includes syntax parsing circuits and a syntax parsing control circuit. The syntax parsing control circuit fetches a start point from the second buffer, assigns the fetched start point to a syntax parsing circuit, and triggers the selected syntax parsing circuit to start syntax parsing of a bitstream segment that is read from the first buffer according to the fetched start point.

### CROSS REFERENCE TO RELATED APPLICATIONS

This application claims the benefit of U.S. provisional application No. 62/361,096, filed on Jul. 12, 2016 and incorporated herein by reference.

### BACKGROUND

The disclosed embodiments of the present invention relate to video data processing, and more particularly, to a video processing system with multiple syntax parsing circuits and/or multiple post decoding circuits.

One conventional video system design may include a video transmitting system (or a video recording system) and a video receiving system (or a video playback system). Regarding the video transmitting system/video recording system, it may include a video encoder, an audio/video multiplexing circuit, and a transmitting circuit. Regarding the video receiving system/video playback system, it may include a receiving circuit, an audio/video demultiplexing circuit, a video decoder and a display engine. However, the conventional video system design may fail to meet the requirements of some ultra-low latency applications due to long recording latency at the video transmitting system/video recording system and long playback latency at the video receiving system/video playback system. In general, entropy decoding is a performance bottleneck of video decoding, and the performance of entropy decoding is sensitive to bitrate. High bitrate achieves better quality, but results in large latency. In general, a single entropy decoding circuit has a highest bitrate limit according to its capability. Hence, using a single entropy decoding circuit may fail to meet the requirement of a low-latency and high-performance video receiving system/video playback system.

### SUMMARY

In accordance with exemplary embodiments of the present invention, a video processing system with multiple syntax parsing circuits and/or multiple post decoding circuits is proposed to solve the above-mentioned problem.

According to a first aspect of the present invention, an exemplary video processing system is provided. The exemplary video processing system includes a storage device, a demultiplexing circuit, and a syntax parser. The storage device includes a first buffer and a second buffer. The demultiplexing circuit is arranged to receive an input bitstream, and perform a demultiplexing operation upon the input bitstream to write a video bitstream into the first buffer and write a plurality of start points of a plurality of bitstream segments of the video bitstream stored in the first buffer into the second buffer, wherein each start point is indicative of a start address of a corresponding bitstream segment stored in the first buffer. The syntax parser includes a plurality of syntax parsing circuits and a syntax parsing control circuit. The syntax parsing control circuit is arranged to fetch a first start point from the second buffer, assign the fetched first start point to a first syntax parsing circuit that is an idle syntax parsing circuit selected from the syntax parsing circuits, and trigger the selected first syntax parsing circuit to start syntax parsing of a first bitstream segment that is read from the first buffer according to the fetched first start point.

According to a second aspect of the present invention, an exemplary video processing system is disclosed. The exemplary video processing system includes a storage device, a demultiplexing circuit, a syntax parser, and a post decoder. The storage device has a first buffer and a second buffer. The demultiplexing circuit is arranged to receive an input bitstream, and perform a demultiplexing operation upon the input bitstream to write a video bitstream into the first buffer. The syntax parser is arranged to perform syntax parsing upon a plurality of bitstream segments of the video bitstream to generate a plurality of universal binary entropy (UBE) syntax data segments, respectively, and write the UBE syntax data segments into the second buffer, wherein each of the bitstream segments contains arithmetic-encoded syntax data, and each of the UBE syntax data segments contains no arithmetic-encoded syntax data. The post decoder includes a plurality of post decoding circuits, each comprising an UBE syntax decoder arranged to perform UBE syntax decoding upon one UBE syntax data segment read from the second buffer to output decoded syntax data. The post decoding control circuit is arranged to assign a first UBE start point to a first post decoding circuit that is an idle post decoding circuit selected from the post decoding circuits, and trigger the selected first post decoding circuit to start post decoding of a first UBE syntax data segment that is read from the second buffer according to the first UBE start point, wherein the first UBE start point is indicative of a start address of the first UBE syntax data segment stored in the second buffer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a video processing system according to an embodiment of the present invention.

FIG. 2 is a diagram illustrating a two-phase syntax parsing apparatus according to an embodiment of the present invention.

FIG. 3 illustrates a first example of a two-phase syntax parsing apparatus according to an embodiment of the present invention.

FIG. 4 illustrates a second example of a two-phase syntax parsing apparatus according to an embodiment of the present invention.

FIG. 5 is a diagram illustrating a first partitioning design of a video frame according to an embodiment of the present invention.

FIG. 6 is a diagram illustrating a second partitioning design of a video frame according to an embodiment of the present invention.

FIG. 7 is a flowchart illustrating a method of controlling the syntax parsing process of one video frame according to an embodiment of the present invention.

FIG. 8 is a flowchart illustrating a method of controlling the post decoding process of one video frame according to an embodiment of the present invention.

FIG. 9 is a diagram illustrating a two-phase syntax parsing operation performed using two syntax parsing circuits in a syntax parser and three post decoding circuits in a post decoder according to an embodiment of the present invention.

FIG. 10 is a diagram illustrating a first storage status of a ring buffer allocated in a UBE syntax data buffer according to an embodiment of the present invention.

FIG. 11 is a diagram illustrating a second storage status of the ring buffer allocated in the UBE syntax data buffer according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

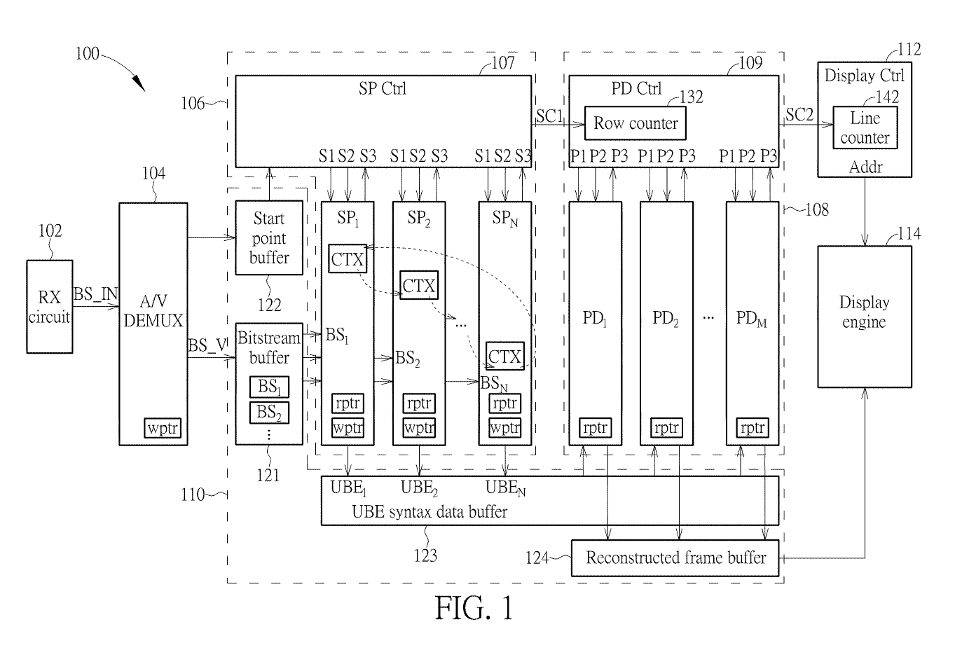

FIG. 1 is a diagram illustrating a video processing system according to an embodiment of the present invention. For example, the video processing system 100 may be a video receiving system (or a video playback system) employed by an ultra-low latency application such as a virtual reality (VR) application. In this embodiment, the video processing system 100 includes a receiving (RX) circuit 102, an audio/video demultiplexing circuit (denoted by “A/V DEMUX”) 104, a syntax parser 106, a post decoder 108, a storage device 110, a display control circuit (denoted by “Display Ctrl”), and a display engine 114. The video processing system 100 employs a two-phase syntax parsing scheme, such that the syntax parser 106 transforms an arithmetic-encoded bitstream (e.g., data-dependency context-adaptive binary arithmetic coding (CABAC) entropy coding bitstream) into a non-data-dependency universal binary entropy (UBE) syntax bitstream, and the UBE syntax decoding in the post decoder 108 can perform parallel UBE syntax decoding to achieve higher decoding performance. In this embodiment, the syntax parser 106 includes a syntax parsing control circuit (denoted by “SP Ctrl”) 107 and a plurality of syntax parsing circuits SP₁, SP₂, . . . , SP_{N}, and the post decoder 108 includes a post decoding control circuit (denoted by “PD Ctrl”) 109 and a plurality of post decoding circuits PD₁, PD₂, . . . , PD_{M}. The integer value N may be same as or different from the integer value M, depending upon actual design considerations.

In this embodiment, the storage device 110 may be implemented using an internal storage device, an external storage device, or a combination of an internal storage device and an external storage device. For example, the internal storage device may be a static random access memory (SRAM) or may be flip-flops; and the external storage device may be a dynamic random access memory (DRAM), a flash memory, a hard disk or a soft disk. As shown in FIG. 1, the storage device 110 may be regarded as having a plurality of buffers allocated therein, such as a bitstream buffer 121, a start point buffer 122, an UBE syntax data buffer 123, and a reconstructed frame buffer 124.

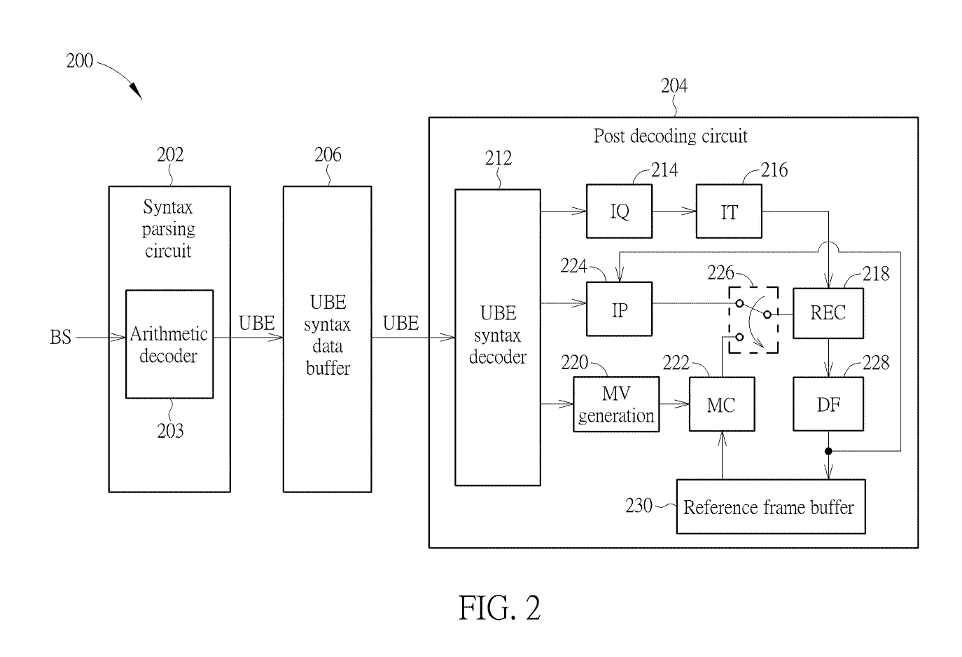

FIG. 2 is a diagram illustrating a two-phase syntax parsing apparatus according to an embodiment of the present invention. For simplicity and clarity, the two-phase syntax parsing apparatus 200 is shown having one syntax parsing circuit 202 and one post decoding circuit 204. However, this is for illustrative purposes only, and is not meant to be a limitation of the present invention. The two-phase syntax parsing apparatus 200 may have multiple syntax parsing circuits and/or multiple post decoding circuits. For example, the syntax parsing circuit 202 may be any of the syntax parsing circuits SP₁-SP_{N} shown in FIG. 1, and/or the post decoding circuit 204 may be any of the post decoding circuits PD₁-PD_{M} shown in FIG. 1.

The video bitstream BS is an output of an entropy encoder of a video transmitting system (or a video recording system). For example, the entropy encoder may employ an arithmetic coding technique such as CABAC. Hence, the video bitstream BS is an arithmetic-encoded bitstream (e.g., CABAC encoded bitstream). The arithmetic coding is often applied to bit strings generated after prediction and/or quantization. Also, various coding parameters and system configuration information may have to be transmitted. These coding parameters and system configuration information will be binarized into bin strings and then arithmetic-encoded. In short, the arithmetic coding usually is applied to bin strings associated with certain syntax elements such as motion vector difference (MVD), partition mode for a coding unit (CU), sign and absolute value of quantized transform coefficients of prediction residual, etc. As shown in FIG. 2, the syntax parsing circuit 202 has an arithmetic decoder 203. In accordance with the two-phase syntax parsing scheme, the arithmetic decoder 203 acts as a look-ahead bitstream reformatting processing circuit. The video bitstream BS is fed into the arithmetic decoder 203. The video bitstream BS is then arithmetic-decoded to recover a bin string (which is an arithmetic-decoded bin string). This arithmetic-decoded bin string is also referred as a non-arithmetic bin string or an UBE syntax data. The UBE syntax data is then stored into the UBE syntax data buffer 206. If the syntax parsing circuit 202 is one of the syntax parsing circuits SP₁-SP_{N} shown in FIG. 1 and the post decoding circuit 204 is one of the post decoding circuits PD₁-PD_{M} shown in FIG. 1, the UBE syntax data buffer 206 may be the UBE syntax data buffer 123 shown in FIG. 1. When enough UBE syntax data (arithmetic-decoded bin strings) have been buffered in the UBE syntax data buffer 206, the UBE syntax data is then read out from the UBE syntax data buffer 206 and post decoded by the post decoding circuit 204.

As shown in FIG. 2, the post decoding circuit 204 includes a UBE syntax decoder (e.g., a variable length decoder (VLD) or a table look-up circuit) 212. The UBE syntax decoder 212 decodes the UBE syntax data to output decoded syntax data representing prediction residual, various coding parameters and system configuration information. The decoded syntax data will be provided to other processing circuits in the post decoding circuit 204 to reconstruct the video data. For example, other processing circuits may include an inverse quantization circuit (denoted by “IQ”) 214, an inverse transform circuit (denoted by “IT”) 216, a reconstruction circuit (denoted by “REC”) 218, a motion vector calculation circuit (denoted by “MV generation”) 220, a motion compensation circuit (denoted by “MC”) 222, an intra prediction circuit (denoted by “IP”) 224, an inter/intra mode selection circuit 226, an in-loop filter (e.g., a deblocking filter (DF) 228), and a reference frame buffer 230. Since a person skilled in the art should readily understand details of these processing circuits 214-230 included in the post decoding circuit 204, further description is omitted here for brevity.

The two-phase syntax parsing design used by the instant application may be implemented using the arithmetic decoder proposed in the U.S. Patent Application No. 2016/0241854 A1, entitled “ METHOD AND APPARATUS FOR ARITHMETIC DECODING” and incorporated herein by reference. The inventors of the U.S. Patent Application No. 2016/0241854 A1 are also co-authors of the instant application.

In one exemplary design, the UBE syntax data generated from the syntax parsing circuit 202 is an arithmetic-decoded bin string. For example, in HEVC standard, the syntax element last_sig_coeff_x_prefix specifies the prefix of the column position of the last significant coefficient in a scanning order within a transform block. According to the HEVC standard, the syntax element last_sig_coeff_x_prefix is arithmetic coded. Unary codes may be used for binarization of syntax element last_sig_coeff_x_prefix. An exemplary unary code for syntax element last_sig_coeff_x_prefix is shown in Table 1, where a longest code has 6 bits and the bin location is indicated by binIdx.

TABLE 1

| prefixVal | Bin string | | | | | |
|---|---|---|---|---|---|---|
| 0 | 0 | | | | | |
| 1 | 1 | 0 | | | | |
| 2 | 1 | 1 | 0 | | | |
| 3 | 1 | 1 | 1 | 0 | | |
| 4 | 1 | 1 | 1 | 1 | 0 | |
| 5 | 1 | 1 | 1 | 1 | 1 | 0 |
| . . . | | | | | | |
| binIdx | 0 | 1 | 2 | 3 | 4 | 5 |

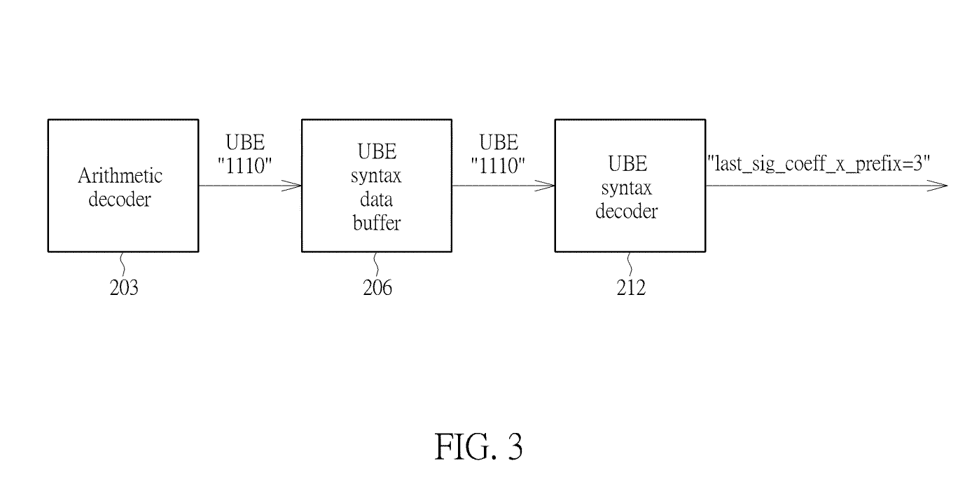

At the encoder side, the prefix values prefixVal for the column position of the last significant coefficient in scanning order are binarized into respective bin strings. For example, the prefix value prefixVal equal to 3 is binarized into “1110”. The binarized bin strings are further encoded using arithmetic coding. According to an embodiment of the present invention, the arithmetic-encoded bitstream is processed by the arithmetic decoder 203 (which acts as a look-ahead bitstream reformatting processing circuit) at the decoder side as shown in FIG. 3. The arithmetic-decoded bin string “1110” from the arithmetic decoder 203 (which acts as a look-ahead bitstream reformatting processing circuit) will be stored in the UBE syntax data buffer 206. After enough bin strings are available, the stored bin string “1110” is then provided to UBE syntax decoder (e.g., VLD with no arithmetic decoding) 212 to recover the syntax, i.e., last_sig_coeff_x_prefix=3.

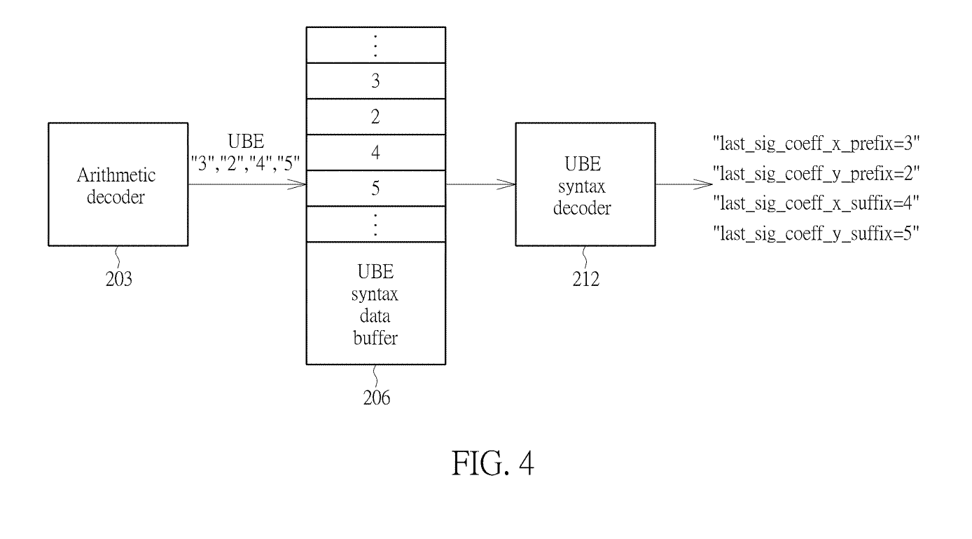

Alternatively, the UBE syntax data generated from the syntax parsing circuit 202 is composed of decoded syntax values with specific data structure in the UBE syntax data buffer 206. For example, in HEVC standard, syntax element last_sig_coeff_x_prefix specifies the prefix of the column position of the last significant coefficient in a scanning order within a transform block, syntax element last_sig_coeff_y_prefix specifies the prefix of the row position of the last significant coefficient in a scanning order within a transform block, syntax element last_sig_coeff_x_suffix specifies the suffix of the column position of the last significant coefficient in a scanning order within a transform block, and syntax element last_sig_coeff_y_suffix specifies the suffix of the row position of the last significant coefficient in a scanning order within a transform block. According to the HEVC standard, syntax elements last_sig_coeff_x_prefix, last_sig_coeff_y_prefix, last_sig_coeff_x_suffix, last_sig_coeff_y_suffix are arithmetic coded. According to an embodiment of the present invention, the arithmetic encoded bitstream is processed by the arithmetic decoder 203 (which acts as a look-ahead bitstream reformatting processing circuit) at the decoder side as shown in FIG. 4. The arithmetic-decoded syntax values “3”, “2”, “4”, “5” of syntax elements last_sig_coeff_x_prefix, last_sig_coeff_y_prefix, last_sig_coeff_x_suffix, last_sig_coeff_y_suffix are obtained by the arithmetic decoder 203 (which acts as a look-ahead bitstream reformatting processing circuit) and stored into specific storage positions in the UBE syntax data buffer 206 according to the specific data structure. That is, a first particular storage space allocated in the UBE syntax data buffer 206 is dedicated to recording a decoded prefix value of syntax element last_sig_coeff_x_prefix, a second particular storage space allocated in the UBE syntax data buffer 206 is dedicated to recording a decoded prefix value of syntax element last_sig_coeff_y_prefix, a third particular storage space allocated in the UBE syntax data buffer 206 is dedicated to recording a decoded suffix value of syntax element last_sig_coeff_x_suffix, and a fourth particular storage space allocated in the UBE syntax data buffer 206 is dedicated to recording a decoded suffix value of syntax element last_sig_coeff_y_suffix. After enough syntax values are available, the stored syntax values “3”, “2”, “4”, “5” are then provided to UBE syntax decoder (e.g., a table look-up circuit) 212 to recover the syntax, i.e., last_sig_coeff_x_prefix=3, last_sig_coeff_y_prefix=2, last_sig_coeff_x_suffix=4, and last_sig_coeff_y_suffix=5. This alternative design also falls within the scope of the present invention.

The arithmetic coding process is very data dependent and often causes decoding throughput concern. In order to overcome this issue, the two-phase syntax parsing scheme decouples the arithmetic decoding from the UBE syntax decoding (which is non-arithmetic decoding) by storing the UBE syntax data (which contains no arithmetic-encoded syntax data) into the UBE syntax data buffer 206. Since the UBE syntax decoder 212 is relatively simple compared to the arithmetic decoder 203, the system design only needs to focus on a throughput issue for the syntax parser. As shown in FIG. 1, the syntax parser 106 is configured to have multiple syntax parsing circuits SP₁-SP_{N}. In addition, the post decoder 108 is configured to have multiple post decoding circuits PD₁-PD_{M}. In one exemplary implementation, the syntax parsing circuit 202 shown in FIG. 2 may be any of the syntax parsing circuits SP₁-SP_{N} shown in FIG. 1, and the post decoding circuit 204 shown in FIG. 2 may be any of the post decoding circuit PD₁-PD_{M}. Hence, the syntax parser 106 and the post decoder 108 are parts of a two-phase syntax parsing apparatus. The use of multiple syntax parsing circuits SP₁-SP_{N} can increase the processing speed of the syntax parsing/arithmetic decoding, and the use of the multiple post decoding circuits PD₁-PD_{M} can increase the processing speed of the UBE syntax decoding/non-arithmetic decoding as well as the reconstructed frame generation. Further details of the video processing system 100 shown in FIG. 1 are described as below.

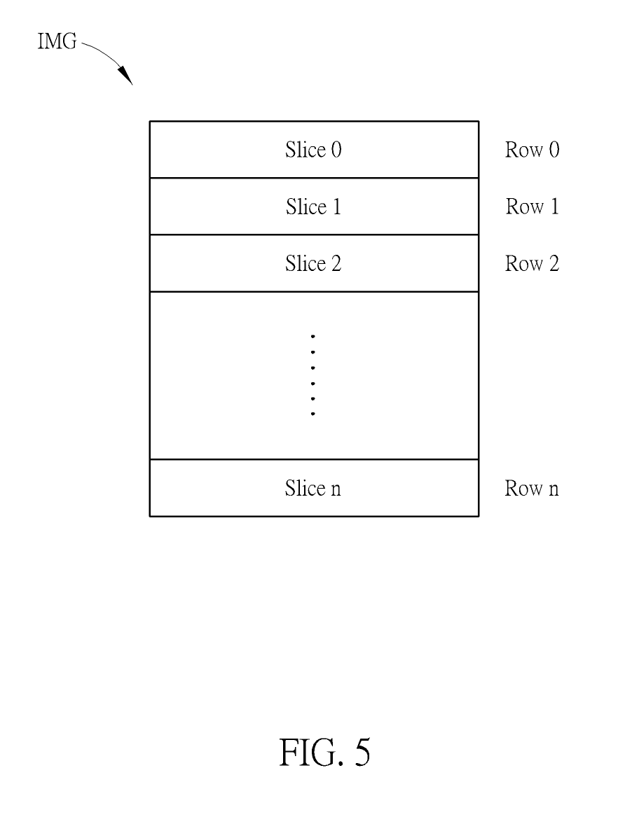

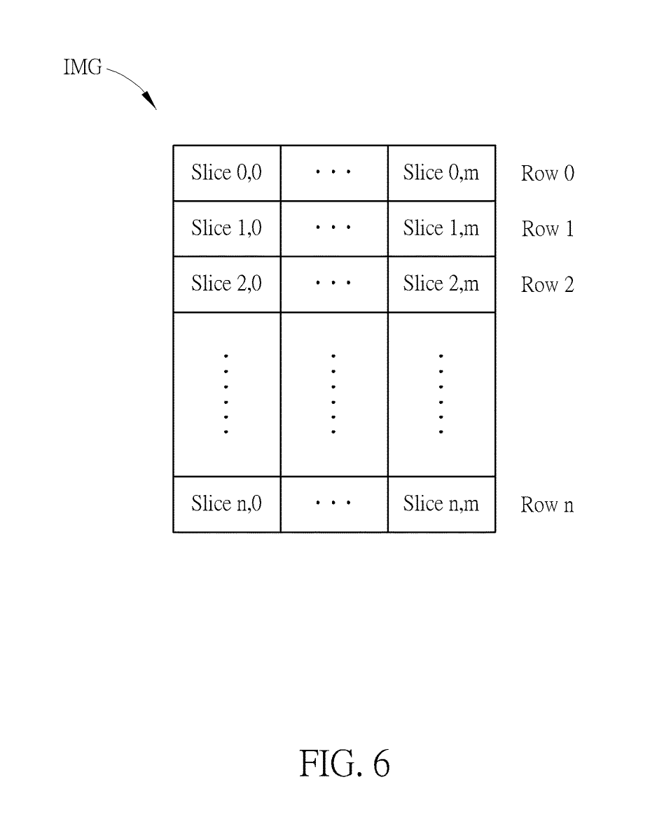

A coding block is a basic processing unit of a video coding standard. For example, when the video coding standard is H.264, one coding block is one macroblock (MB). For another example, when the video coding standard is VP9, one coding block is one super block (SB). For yet another example, when the video coding standard is HEVC (High Efficiency Video Coding), one coding block is one coding tree unit (CTU). In this embodiment, one video frame is partitioned into a plurality of slices, such that each of the slices includes a portion of the video frame. Since the common term “slice” is well defined in a variety of video coding standards, further description is omitted here for brevity. FIG. 5 is a diagram illustrating a first partitioning design of a video frame according to an embodiment of the present invention. One video frame IMG may have a plurality of coding block rows (e.g., MB rows, SB rows, or CTU rows) Row 0, Row 1, Row 2, . . . , Row n, each having a plurality of coding blocks (e.g., MBs, SBs, or CTUs). In accordance with the first partitioning design, each coding block row is one slice. Hence, the video frame IMG is partitioned into slices Slice 0, Slice 1, Slice 2, . . . , Slice n. FIG. 6 is a diagram illustrating a second partitioning design of a video frame according to an embodiment of the present invention. One video frame IMG may have a plurality of coding block rows (e.g., MB rows, SB rows, or CTU rows) Row 0, Row 1, Row 2, . . . , Row n, each having a plurality of coding blocks (e.g., MBs, SBs, or CTUs). In accordance with the second partitioning design, each coding block row contains a plurality of slices. Hence, the video frame IMG is partitioned into slices Slice 0,0-Slice 0,m, Slice 1,0-Slice 1,m, Slice 2,0-Slice 2,m, . . . , Slice n,0-Slice n,m. The video processing system 100 with multiple syntax parsing circuits SP₁-SP_{N} and multiple post decoding circuits PD₁-PD_{M} may be used under the premise that one video frame is partitioned into multiple slices, where a slice can contain partial or whole encoded data of one coding block row (e.g., MB/SB/CTU row), but cannot contain partial or whole encoded data of multiple coding block rows (e.g., MB/SB/CTU rows).

Regarding video processing and video playback, the RX circuit 102 may receive a wireless transmission signal (e.g., a WiFi signal) from a video transmission system (or a video recording system), and may extract an input bitstream BS IN from the wireless transmission signal, where the input bitstream BS IN may include encoded video data and encoded audio data. The A/V demultiplexing circuit 104 receives the input bitstream BS IN and performs A/V demultiplexing upon the input bitstream BS IN, such that a video bitstream BS V is extracted from the input bitstream BS IN and written into the bitstream buffer 121 of the storage device 110. In addition, the A/V demultiplexing circuit 104 further writes a plurality of start points of a plurality of bitstream segments of the video bitstream BS V stored in the bitstream buffer 121 into the start point buffer 122, wherein each start point is indicative of a start address of a corresponding bitstream segment stored in the bitstream buffer 121. For example, each bitstream segment is composed of bitstream data of one coding block row (e.g., MB/SB/CTU row). Hence, the bitstream segment BS₁ includes encoded data of the one coding block row (e.g., MB/SB/CTU row) in a video frame, and the bitstream segment BS₂ includes encoded data of the next coding block row (e.g., MB/SB/CTU row) in the video frame. One start point indicative of the start address of the bitstream segment BS₁ stored in the bitstream buffer 121 is stored in the start point buffer 122, and another start point indicative of the start address of the bitstream segment BS₂ stored in the bitstream buffer 121 is stored in the start point buffer 122.

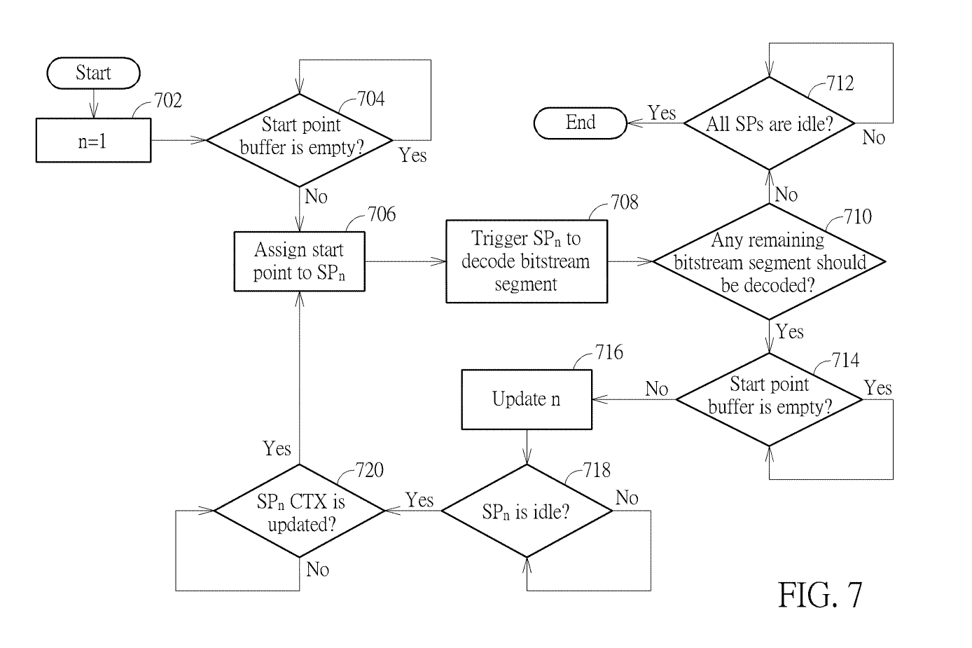

The syntax parsing control circuit 107 manages the syntax parsing process (arithmetic decoding process) of the bitstream segments stored in the bitstream buffers. For example, as shown in FIG. 1, the syntax parsing control circuit 107 assigns a start point S1 to one syntax parsing circuit, outputs a control signal S2 to stall one syntax parsing circuit, and receives a notification signal S3 indicative of an idle state of one syntax parsing circuit. FIG. 7 is a flowchart illustrating a method of controlling the syntax parsing process of one video frame according to an embodiment of the present invention. Provided that the result is substantially the same, the steps are not required to be executed in the exact order shown in FIG. 7. The method shown in FIG. 7 may be employed by the syntax parsing control circuit 107. At step 702, the syntax parsing control circuit 107 initializes an index value n by 1 (i.e., n=1). At step 704, the syntax parsing control circuit 107 monitors a buffer status of the start point buffer 122 to check if the start point buffer 122 is empty. If the buffer status of the start point buffer 122 indicates that the start point buffer 122 is empty, it means the start point buffer 122 has no start point currently waiting to be fetched and dispatched. Hence, the syntax parsing control circuit 107 keeps monitoring the buffer status of the start point buffer 122 (step 704).

If the buffer status of the start point buffer 122 indicates that the start point buffer 122 is not empty, it means the start point buffer 122 has one or more start points currently waiting to be fetched and dispatched. Initially, the syntax parsing circuits SP₁-SP_{N} are all idle. At step 706, the syntax parsing control circuit 107 fetches one start point (e.g., a start point of a bitstream segment BS₁) from the start point buffer 122, and assigns the fetched start point S1 to an idle syntax parsing circuit SPₙ with the index value n (n=1). At step 708, the syntax parsing control circuit 107 triggers the selected syntax parsing circuit SPₙ (n=1) to start syntax parsing (arithmetic decoding) of a bitstream segment (e.g., bitstream segment BS₁) that is read from the bitstream buffer 121 according to the fetched start point S1. When the selected syntax parsing circuit SPₙ (n=1) finishes syntax parsing (arithmetic decoding) of the bitstream segment (e.g., bitstream segment BS₁), it returns to an idle state, and notifies the syntax parsing control circuit 107 of the idle state by sending one notification signal S3.

Since the bitstream segment BS₁ corresponds to the first coding block row (i.e., the uppermost coding block row) of one video frame, a context table CTX for arithmetic decoding (e.g., CABAC decoding) is initialized by a default setting. During the syntax parsing (arithmetic decoding) of the bitstream segment (e.g., bitstream segment BS₁), the syntax parsing circuit SPₙ (n=1) updates the context table CTX each time one decoded bin/symbol is generated, and the updated context table CTX is referenced for syntax parsing (arithmetic decoding) of the following arithmetic-encoded data. Moreover, in accordance with HEVC, Wavefront Parallel Processing (WPP) allows each CTU row to be encoded/decoded in parallel. If a current CTU row is not the uppermost CTU row in one video frame, a context table CTX for encoding/decoding the current CTU row is initialized by a context table CTX updated at a specific position in an upper CTU row. Hence, when the video bitstream BS_V is generated under the HEVC WPP process, the context table CTX updated by one syntax parsing circuit during decoding of one CTU row may be used to initialize the context table CTX used by another syntax parsing circuit for decoding the next CTU row.

At step 710, the syntax parsing control circuit 107 checks if there is any remaining bitstream segment of one video frame that should be decoded. If all bitstream segments of the same video frame have been processed by the syntax parser 106, the syntax parsing control circuit 107 checks if all syntax parsing circuits SP₁-SP_{N} are idle (step 712). If all of the syntax parsing circuits SP₁-SP_{N} are idle, it means the syntax parsing (arithmetic decoding) of one video frame is completed. Hence, the syntax parsing process of one video frame is ended.

If at least one bitstream segment of the video frame is not processed by the syntax parser 106 yet, the syntax parsing control circuit 107 checks the buffer status of the start point buffer 122 to determine if the start point buffer 122 is empty (step 714). If the buffer status of the start point buffer 122 indicates that the start point buffer 122 is empty, it means the start point buffer 122 has no start point currently waiting to be fetched and dispatched. Hence, the syntax parsing control circuit 107 keeps monitoring the buffer status of the start point buffer 122 (step 714). If the buffer status of the start point buffer 122 indicates that the start point buffer 122 is not empty, it means the start point buffer 122 has one or more start points currently waiting to be fetched and dispatched. At step 716, the syntax parsing control circuit 107 updates the index value n according to the following pseudo code.

```
if (n=N)
  n=1
else
  n=n+1
```

In this embodiment, the syntax parsing circuits SP₁-SP_{N} will be selected for processing bitstream segments of successive coding block rows (e.g., MB/SB/CTU rows), sequentially and cyclically. Hence, if the syntax parsing circuit SPₙ that is most recently selected and used is SP_{N}, the next syntax parsing circuit SPₙ that will be selected and used is SP₁; and if the syntax parsing circuit SPₙ that is most recently selected and used is not SP_{N}, the next syntax parsing circuit SPₙ that will be selected and used is SPₙ₊₁. At step 718, the syntax parsing control circuit 107 checks if the selected syntax parsing circuit SPₙ with the updated index value n (n=1 or n=n+1) is idle. If the selected syntax parsing circuit SPₙ with the updated index value n (n=1 or n=n+1) is not idle yet, it means the selected syntax parsing circuit SPₙ with the updated index value n (n=1 or n=n+1) is still processing a previous bitstream segment. Hence, the syntax parsing control circuit 107 waits for the selected syntax parsing circuit SPₙ entering an idle state (step 718). If the selected syntax parsing circuit SPₙ with the updated index value n (n=1 or n=n+1) is idle, the syntax parsing control circuit 107 checks if the context table CTX of the selected syntax parsing circuit SPₙ with the updated index value n (n=1 or n=n+1) is updated/initialized (step 720). If the context table CTX of the selected syntax parsing circuit SPₙ with the updated index value n (n=1 or n=n+1) is updated/initialized, the syntax parsing control circuit 107 fetches one start point S1 (e.g., a start point of the next bitstream segment BS₂) from the start point buffer 122, and assigns the fetched start point S1 to the idle syntax parsing circuit SPₙ with the updated index value n (e.g., n=2) (step 706).

The processing time of syntax parsing of a first bitstream segment that is performed by a first syntax parsing circuit SPₙ with the index value n set by a first value (e.g., n=1) can overlap the processing time of syntax parsing of a second bitstream segment that is performed by a second syntax parsing circuit SPₙ with the index value n set by a second value (e.g., n=2). In this way, the syntax parsing performance (arithmetic decoding performance) of the syntax parser 106 used in the two-phase syntax parsing scheme can be improved by using multiple syntax parsing circuits SP₁-SP_{N}.

It should be noted that step 720 may be optional. For example, when the video bitstream BS_V is generated under the HEVC WPP process, step 720 is included in the control flow shown in FIG. 7; and when the video bitstream BS_V is not generated under the HEVC WPP process, step 720 is omitted from the control flow shown in FIG. 7.

There is data dependency between syntax parsing (arithmetic decoding) of bitstream segments of different coding block rows (e.g., MB/SB/CTU rows). Hence, the syntax parsing control circuit 107 further monitors syntax parsing progresses of different bitstream segments that are currently processed by different syntax parsing circuits. For example, the different bitstream segments include a first bitstream segment of a first coding block row in a video frame and a second bitstream segment of a second coding block row in the same video frame, where the first coding block row and the second coding block row are adjacent coding block rows, and the first coding block row is above the second coding block row. When the first bitstream segment is dispatched to a first syntax parsing circuit for syntax parsing (arithmetic decoding) and the second bitstream segment is dispatched to a second syntax parsing circuit for syntax parsing (arithmetic decoding), the syntax parsing control circuit 107 monitors the syntax parsing of the first bitstream segment and the syntax parsing of the second bitstream segment, and outputs a control signal S2 to the second syntax parsing circuit to stall the syntax parsing of the second bitstream segment when a spatial neighbor data needed by the syntax parsing of the second bitstream segment is not derived from the syntax parsing of the first bitstream segment yet. For example, the first syntax parsing circuit and the second syntax parsing circuit are successively selected and triggered by the syntax parsing control circuit 107 for processing the first bitstream segment and the second bitstream segment in order. That is, if the second syntax parsing circuit SPₚ (p=1˜N) is a currently selected syntax parsing circuit, the first syntax parsing circuit Previous_SP (SPₚ) is a previously selected syntax parsing circuit. The first syntax parsing circuit Previous_SP (SPₚ) may be defined using the following pseudo code.

```
if p=1
  Previous_SP (SPₚ) = SP_{N}
else
  Previous_SP (SPₚ) = SP₍ₚ₋₁₎
```

For example, if the second syntax parsing circuit SPₚ is SP₁, the first syntax parsing circuit Previous_SP (SPₚ) is SP_{N}. For another example, if the second syntax parsing circuit SPₚ is SP₂, the first syntax parsing circuit Previous_SP (SPₚ) is SP₁. For yet another example, if the second syntax parsing circuit SPₚ is SP_{N}, the first syntax parsing circuit Previous_SP (SPₚ) is SP_{(N-1)}.

The syntax parsing control circuit 107 monitors a current processing coordinate pu_x of the second syntax parsing circuit SPₚ and a current processing coordinate pu_x of the first syntax parsing circuit Previous_SP (SPₚ) to determine if the spatial neighbor data is available to the second syntax parsing circuit SPₚ, where the current processing coordinate pu_x represents a column position of a coding block (e.g., MB, SB, or CTU) currently being processed by one syntax parsing circuit. If the coordinate (pu_x+TH1) of the first syntax parsing circuit Previous_SP (SPₚ) is less than or equal to the current processing coordinate pu_x of the second syntax parsing circuit SPₚ, the syntax parsing control circuit 107 determines that the spatial neighbor data is not available to the second syntax parsing circuit SPₚ, and outputs a control signal S2 for instructing the second syntax parsing circuit SPₚ to stall the syntax parsing of the second bitstream segment. Otherwise, the second syntax parsing circuit SPₚ works normally to perform the syntax parsing of the second bitstream segment. The threshold value TH1 may be a positive number that is set based on the design considerations.

When any of the syntax parsing circuits SP₁-SP_{N} finishes the syntax parsing (arithmetic decoding) of one bitstream segment, a UBE syntax data segment is stored in the UBE syntax data buffer 123. For example, the syntax parsing circuits SP₁-SP_{N} are used to process the bitstream segments BS₁-BS_{N} read from the bitstream buffer 121, respectively; and the syntax parsing circuits SP₁-SP_{N} outputs UBE syntax data segments UBE₁-UBE_{N} to the UBE syntax data buffer 123, respectively. It should be noted that, each of the bitstream segments BS₁-BS_{N} contains arithmetic-encoded syntax data, while each of the UBE syntax data segments UBE₁-UBE_{N} contains no arithmetic-encoded syntax data.

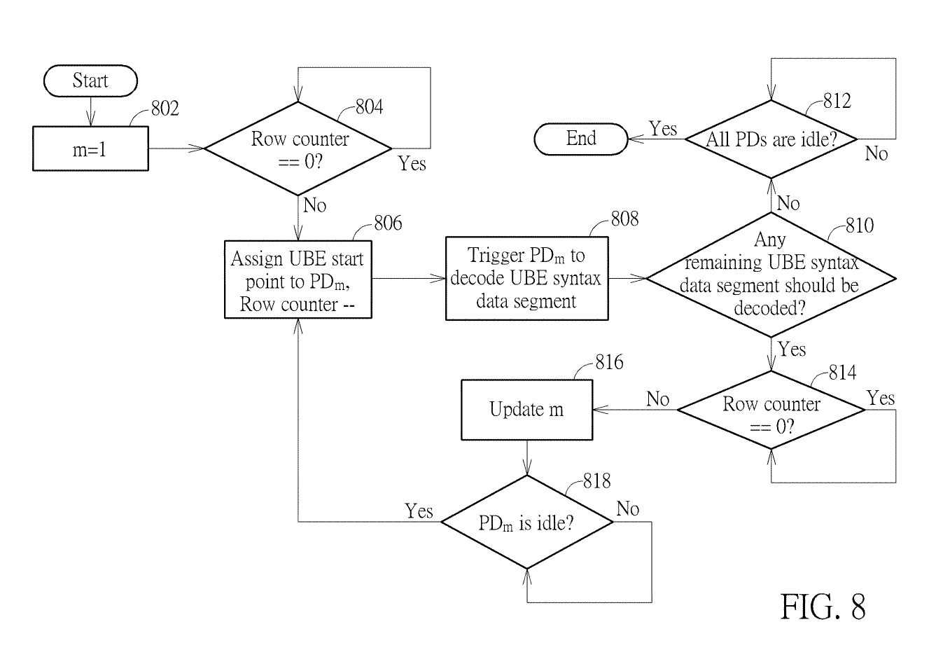

The post decoding control circuit 109 manages the post decoding process (which includes a non-arithmetic decoding process) of the UBE syntax data segments stored in the UBE syntax data buffer 123. For example, as shown in FIG. 1, the post decoding control circuit 109 assigns a UBE start point P1 to one post decoding circuit, outputs a control signal P2 to stall one post decoding circuit, and receives a notification signal P3 indicative of an idle state of one post decoding circuit. FIG. 8 is a flowchart illustrating a method of controlling the post decoding process of one video frame according to an embodiment of the present invention. Provided that the result is substantially the same, the steps are not required to be executed in the exact order shown in FIG. 8. The method shown in FIG. 8 may be employed by the post decoding control circuit 109. At step 802, the post decoding control circuit 109 initializes an index value m by 1 (i.e., m=1). At step 804, the post decoding control circuit 109 checks a count value maintained by a row counter 132 to determine if the UBE syntax data buffer 123 has any UBE syntax data segment currently waiting to be post decoded. In this embodiment, the row counter 132 updates its count value in response to one notification signal SC1 generated from the syntax parsing control circuit 107 each time syntax parsing of one bitstream segment is completed by one of the syntax parsing circuits SP₁-SP_{N}. For example, the count value of the row counter 132 is increased by an increment value (e.g., 1) each time one UBE syntax data segment is generated from syntax parsing of one bitstream segment of one coding block row. Hence, the count value maintained by the row counter 132 indicates if the UBE syntax data buffer 123 has any UBE syntax data segment currently waiting to be post decoded. If the count value of the row counter 132 is equal to zero, it means the UBE syntax data buffer 123 has no UBE syntax data segment currently waiting to be post decoded. Hence, the post decoding control circuit 109 keeps monitoring the row counter 132 (step 804).

If the count value maintained by the row counter 132 is larger than zero, it means the UBE syntax data buffer 123 has one or more UBE syntax data segments currently waiting to be post decoded. Initially, the post decoding circuits PD₁-PD_{M} are all idle. At step 806, the post decoding control circuit 109 assigns a UBE start point P1 (e.g., a start address of the UBE syntax data segment UBE₁ stored in the UBE syntax data buffer 123) to the idle syntax parsing circuit PDₘ with the index value m (m=1), and decreases the count value of the row counter 132 by a decrement value (e.g., 1). In this embodiment, each UBE start point is indicative of a start address of a corresponding UBE syntax data segment stored in the UBE syntax data buffer 123. At step 808, the post decoding control circuit 109 triggers the selected post decoding circuit PDₘ (m=1) to start post decoding (which includes non-arithmetic decoding) of the UBE syntax data segment (e.g., UBE syntax data segment UBE₁) that is read from the UBE syntax data buffer 123 according to the assigned UBE start point Pl. When the selected post decoding circuit PDₘ (m=1) finishes post decoding of the UBE syntax data segment (e.g., UBE syntax data segment UBE₁), it returns to an idle state, and notifies the post decoding control circuit 109 of the idle state by sending one notification signal P3.

At step 810, the post decoding control circuit 109 checks if there is any remaining UBE syntax data segment of one video frame that should be decoded. If all UBE syntax data segments of the same video frame have been processed by the post decoder 108, the post decoding control circuit 109 checks if all post decoding circuits PD₁-PD_{M} are idle (step 812). If all of the post decoding circuits PD₁-PD_{M} are idle, it means the post decoding (which includes non-arithmetic decoding) of one video frame is completed. Hence, the post decoding process of one video frame is ended.

If at least one UBE syntax data segment of the video frame is not processed by the post decoder 108 yet, the post decoding control circuit 109 checks the count value maintained by the row counter 132 to determine if the UBE syntax data buffer 123 has any UBE syntax data segment currently waiting to be post decoded (step 814). If the count value of the row counter 132 is equal to zero, it means the UBE syntax data buffer 123 has no UBE syntax data segment currently waiting to be post decoded. Hence, the post decoding control circuit 109 keeps monitoring the row counter 132 (step 814). If the count value of the row counter 132 is larger than zero, it means the UBE syntax data buffer 123 has one or more UBE syntax data segments currently waiting to be post decoded. At step 816, the post decoding control circuit 109 updates the index value m according to the following pseudo code.

```
if (m=M)
  m=1
else
  m=m+1
```

In this embodiment, the post decoding circuits PD₁-PD_{M} will be selected for processing UBE syntax data segments of successive coding block rows (e.g., MB/SB/CTU rows), sequentially and cyclically. Hence, if the post decoding circuit PDₘ that is most recently selected and used is PDₘ, the next post decoding circuit PDₘ that will be selected and used is PD₁; and if the post decoding circuit PDₘ that is most recently selected and used is not PD_{M}, the next post decoding circuit PDₘ that will be selected and used is PDₘ₊₁. At step 818, the post decoding control circuit 109 checks if the selected post decoding circuit PDₘ with the updated index value m (m=1 or m=m+1) is idle. If the selected post decoding circuit SPₘ with the updated index value m (m=1 or m=m+1) is not idle yet, it means the selected post decoding circuit PDₘ with the updated index value m (m=1 or m=m+1) is still processing a previous UBE syntax data segment. Hence, the post decoding control circuit 109 waits for the selected post decoding circuit PDₘ entering an idle state (step 818). If the selected post decoding circuit PDₘ with the updated index value m (m=1 or m=m+1) is idle, the post decoding control circuit 109 assigns a UBE start point P1 (e.g., a start address of UBE syntax data segment UBE₂ stored in UBE syntax data buffer 123) to the idle syntax parsing circuit PDₘ with the index value m (e.g., m=2), and decreases the count value of the row counter 132 by a decrement value (e.g., 1) (step 806).

As mentioned above, the count value of the row counter 132 is increased by an increment value (e.g., 1) each time one UBE syntax data segment is generated from syntax parsing of one bitstream segment of one coding block row. With regard to the exemplary control flow shown in FIG. 8, the count value of the row counter 132 is decreased by a decrement value (e.g., 1) each time a UBE start point is assigned to one idle syntax parsing circuit. Hence, step 814 is performed to check if the count value maintained by the row counter 132 is larger than zero. When the count value maintained by the row counter 132 is larger than zero, step 814 determines that the UBE syntax data buffer 123 has one or more UBE syntax data segments currently waiting to be post decoded. However, the above is for illustrative purposes only, and is not meant to be a limitation of the present invention. In an alternative design, step 806 may be modified to omit an operation of decreasing the count value of the row counter 132 by a decrement value (e.g., 1). Hence, the count value of the row counter 132 is monotonically increased when syntax parsing of bitstream segments of coding block rows in the same video frame is gradually finished. In other words, during syntax parsing and post decoding of coding block rows of one video frame, a next count value set by the row counter 132 is always larger than a current count value set by the row counter 132. The step 814 may be modified to check if the count value of the row counter 132 is increased to a larger value. When the count value of the row counter 132 is increased to a larger value, it means the UBE syntax data buffer 123 has one or more UBE syntax data segments currently waiting to be post decoded. The same objective of using the count value of the row counter 132 to control the post decoding process is achieved. This alternative design also falls within the scope of the present invention.

The processing time of post decoding of a first UBE syntax data segment that is performed by a first post decoding circuit PDₘ with the index value m set by a first value (e.g., m=1) can overlap the processing time of post decoding of a second UBE syntax segment that is performed by a second post decoding circuit PDₘ with the index value m set by a second value (e.g., m=2). In this way, the post decoding performance of the post decoder 108 used in the two-phase syntax parsing scheme can be improved by using multiple post decoding circuits PD₁-PD_{M} each having one UBE syntax decoder for performing UBE syntax decoding (non-arithmetic decoding).

There is no data dependency between UBE syntax decoding (non-arithmetic decoding) of UBE syntax data segments of different coding block rows (e.g., MB/SB/CTU rows). Hence, UBE syntax decoding (non-arithmetic decoding) of UBE syntax data segments of different coding block rows (e.g., MB/SB/CTU rows) can be performed in a parallel manner. However, as shown in FIG. 2, the post decoding process further includes other decoding stages, including IQ, IT, REC, IP, MC, DF, etc. For example, the DF stage may require spatial neighbor data when applying the DF process to block boundaries in a partial video frame reconstructed from a current coding block row. As a result, there is data dependency between post decoding of UBE syntax data segments of different coding block rows (e.g., MB/SB/CTU rows). In this embodiment, the post decoding control circuit 109 further monitors post decoding progresses of different UBE syntax data segments that are currently processed by different post decoding circuits. For example, the different UBE syntax data segments include a first UBE syntax data segment of a first coding block row in a video frame and a second UBE syntax data segment of a second coding block row in the same video frame, where the first coding block row and the second coding block row are adjacent coding block rows, and the first coding block row is above the second coding block row. When the first UBE syntax data segment is dispatched to a first post decoding parsing circuit for post decoding and the second UBE syntax data segment is dispatched to a second post decoding circuit for post decoding, the post decoding control circuit 109 monitors the post decoding of the first UBE syntax data segment and the post decoding of the second UBE syntax data segment, and outputs a control signal P2 to stall the post decoding of the second UBE syntax data segment when a spatial neighbor data needed by the post decoding of the second UBE syntax data segment is not derived from the post decoding of the first UBE syntax data segment yet. For example, the first post decoding circuit and the second post decoding circuit are successively selected and triggered by the post decoding control circuit 109 for processing the first UBE syntax data segment and the second UBE syntax data segment in order. That is, if the second post decoding circuit PD_{p (p=}1˜M) is a currently selected post decoding circuit, the first post decoding circuit Previous_PD (PDₚ) is a previously selected post decoding circuit. The first post decoding circuit Previous_PD (PDₚ) may be defined using the following pseudo code.

```
if p=1
  Previous_PD (PDₚ) = PD_{M}
else
  Previous_PD (PDₚ) = PD₍ₚ₋₁₎
```

For example, if the second post decoding circuit PDₚ is PD₁, the first post decoding circuit Previous_PD (PDₚ) is PD_{M}. For another example, if the second post decoding circuit PDₚ is PD₂, the first post decoding circuit Previous_PD (PDₚ) is PD₁. For yet another example, if the second post decoding circuit PDₚ is PD_{M}, the first post decoding circuit Previous_PD (PDₚ) is PD₍ₘ₋₁₎.

The post decoding control circuit 109 monitors a current processing coordinate pu_x of the second post decoding circuit PDₚ and a current processing coordinate pu_x of the first post decoding circuit Previous_PD (PDₚ) to determine if the spatial neighbor data is available to the second post decoding circuit PDₚ, where the current processing coordinate pu_x represents a column position of a coding block (e.g., MB, SB, or CTU) currently being decoded by one post decoding circuit. If the coordinate (pu_x+TH2) of the first post decoding circuit Previous_PD (PDₚ) is less than or equal to the current processing coordinate pu_x of the second post decoding circuit PDₚ, the post decoding control circuit 109 determines that the spatial neighbor data is not available to the second post decoding circuit PDₚ, and outputs a control signal P2 for instructing the second post decoding circuit PDₚ to stall the post decoding of the second UBE syntax data segment. Otherwise, the second post decoding circuit PDₚ works normally to perform the post decoding of the second UBE syntax data segment. The threshold value TH2 may be a positive number that is set based on the design considerations.

The two-phase syntax parsing scheme decouples the arithmetic decoding from the UBE syntax decoding (non-arithmetic decoding), uses multiple syntax parsing circuits to perform arithmetic decoding of bitstream segments of different coding block rows (e.g., MB/SB/CTU rows), and uses multiple post decoding circuits to perform post decoding of UBE syntax data segments of different coding block rows (e.g., MB/SB/CTU rows). In this way, a low-latency and high-performance video decoder system can be achieved.

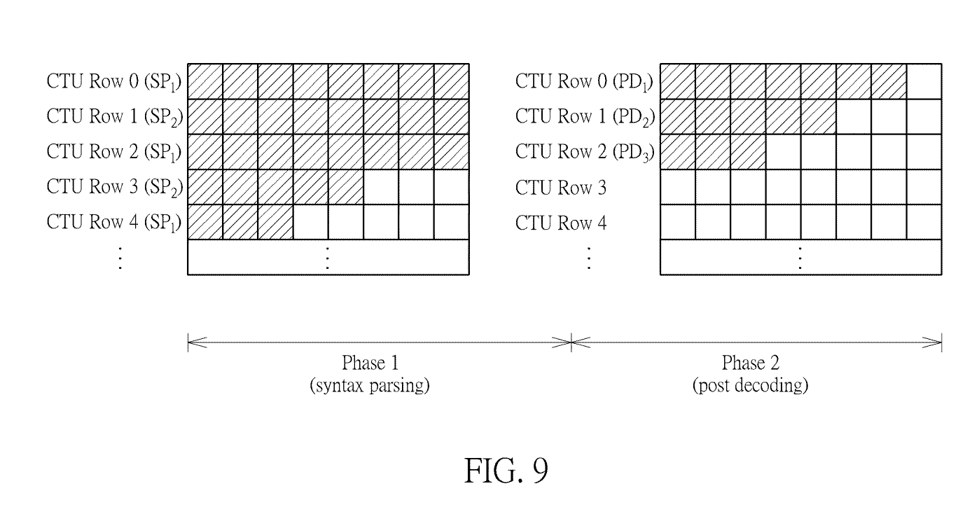

FIG. 9 is a diagram illustrating a two-phase syntax parsing operation performed using two syntax parsing circuits SP₁, SP₂ in a syntax parser and three post decoding circuits PD₁, PD₂, PD₃ in a post decoder according to an embodiment of the present invention. In this example, each coding block row is one CTU row. The left part of FIG. 9 shows the syntax parsing (arithmetic decoding) process that is the first phase of the two-phase syntax parsing scheme, and the right part of FIG. 9 shows the post decoding process (which includes UBE syntax decoding) that is the second phase of the two-phase syntax parsing scheme. Initially, the syntax parsing circuits SP₁, SP₂ and the post decoding circuits PD₁, PD₂, PD₃ are all idle. Hence, at the beginning of the two-phase syntax parsing, the idle syntax parsing circuit SP₁is selected and triggered for processing CTU Row 0. Before syntax parsing of CTU Row 0 is completed by the syntax parsing circuit SP₁, the idle the syntax parsing circuit SP₂ may be selected and triggered for processing CTU Row 1. After syntax parsing of CTU Row 0 is completed by the syntax parsing circuit SP₁, the idle post decoding circuit PD₁ is selected and triggered for processing CTU Row 0, and the idle syntax parsing circuit SP₁ may be selected and triggered for processing CTU Row 2. After syntax parsing of CTU Row 1 is completed by the syntax parsing circuit SP₂, the idle post decoding circuit PD₂ is selected and triggered for processing CTU Row 1, and the idle syntax parsing circuit SP₂ may be selected and triggered for processing CTU Row 3. After syntax parsing of CTU Row 2 is completed by the syntax parsing circuit SP₁, the idle post decoding circuit PD₃ is selected and triggered for processing CTU Row 2, and the idle syntax parsing circuit SP₁ may be selected and triggered for processing CTU Row 4. Due to the use of multiple syntax parsing circuits SP₁ and SP₂, the processing time of syntax parsing (arithmetic decoding) of one coding block row (e.g., CTU Row 3) may overlap the processing time of syntax parsing (arithmetic decoding) of another coding block row (e.g., CTU Row 4). Due to the use of multiple post decoding circuits PD₁-PD₃, the processing time of post decoding (which includes UBE syntax decoding) of one coding block row (e.g., CTU Row 0) may overlap the processing time of post decoding (which includes UBE syntax decoding) of another coding block row (e.g., CTU Row 1 or CTU Row 2). Further, since a row level decoding pipeline between syntax parsing circuits SP₁-SP₂ and post decoding circuits PD₁-PD₃ is employed, the processing time of syntax parsing (arithmetic decoding) of one coding block row (e.g., CTU Row 1) may overlap the processing time of post decoding (which includes UBE syntax decoding) of another coding block row (e.g., CTU Row 0).

In accordance with the row level decoding pipeline between syntax parsing circuits SP₁-SP₂ and post decoding circuits PD₁-PD₃, one post decoding circuit does not start post decoding of a specific CTU row until one syntax parsing decoding circuit finishes syntax parsing of the specific CTU row. However, this is for illustrative purposes only, and is not meant to be a limitation of the present invention. That is, the decoding pipeline between syntax parsing circuits SP₁-SP₂ and post decoding circuits PD₁-PD₃ is not limited to a row level pipeline. Alternatively, the decoding pipeline between syntax parsing circuits SP₁-SP₂ and post decoding circuits PD₁-PD₃ may be a tile level pipeline, a slice level pipeline, or a coding block level pipeline, depending upon the actual design considerations. Hence, with a proper configuration of decoding pipeline between syntax parsing and post decoding, the syntax parser 106 and the post decoder 108 are allowed to process different frames. For example, when the syntax parser 106 performs syntax parsing of bitstream segments of coding block rows of a current video frame, the post decoder 108 may perform post decoding of UBE syntax data segments of coding block rows of a previous video frame. To put it another way, one syntax parsing circuit of the syntax parser 106 may process a coding block row of one video frame while one post decoding circuit of the post decoder 108 is processing a coding block row of a different video frame.

When any of the post decoding circuits PD₁-PD_{M} finishes the post decoding of one UBE syntax data segment associated with one coding block row (e.g., MB/SB/CTU row), a reconstructed frame segment (i.e., a reconstructed partial video frame) is stored in the reconstructed frame buffer 124. As mentioned above, the video processing system 100 may be a video receiving system (or a video playback system) employed by an ultra-low latency application such as a virtual reality (VR) application. Hence, as shown FIG. 1, the video processing system 100 further includes the display control circuit 112 and the display engine 114 for dealing with a video playback process. The display control circuit 112 manages the video playback of the reconstructed frame data stored in the reconstructed frame buffer 124, and the display engine 114 is a driving circuit of a display apparatus (not shown). For example, the display control circuit 112 checks a count value maintained by a line counter 142 to determine if the number of reconstructed pixel lines reaches a predetermined threshold. In this embodiment, the line counter 142 updates its count value in response to one notification signal SC2 generated from the post decoding control circuit 109 each time post decoding of one UBE syntax data segment is completed by one of the post decoding circuits PD₁-PD_{M}. In this embodiment, the count value of the line counter 132 is increased by an increment value (e.g., a value equal to a height of one coding block) each time one reconstructed frame segment is generated from post decoding of one UBE syntax data segment of one coding block row. Hence, the count value of the line counter 142 indicates the number of reconstructed pixel lines of one video frame. When the number of reconstructed pixel lines of one video frame reaches the predetermined threshold, the display control circuit 112 assigns a start address Addr of a reconstructed frame stored in the reconstructed frame buffer 124 to the display engine 114, and triggers the display engine 114 to start displaying of the reconstructed frame. In other words, displaying of the reconstructed frame may be started before all reconstructed pixel lines of the reconstructed frame are obtained by the post decoder 108.

When a video source is in an ultra-high resolution, an amount of UBE syntax data generated from syntax parsing of one video frame may be large. Using the UBE syntax data buffer 123 to fully accommodate all UBE syntax data of a video frame with an ultra-high resolution requires a large buffer size inevitably. To reduce the storage space usage, the present invention further proposes allocating a plurality of ring buffers in the UBE syntax data buffer 123 for the syntax parsing circuits SP₁-SP_{N}, respectively. For example, a first ring buffer is used to buffer the UBE syntax data segment UBE₁ generated from the syntax parsing circuit SP₁, a second ring buffer is used to buffer the UBE syntax data segment UBE₂ generated from the syntax parsing circuit SP₂, and an N^{th} ring buffer is used to buffer the UBE syntax data segment UBE_{N} generated from the syntax parsing circuit SP_{N}. Hence, one ring buffer is used to buffer a syntax parsing output of one particular syntax parsing circuit, where the buffered syntax parsing output in the ring buffer may be post decoded by one or more idle post decoding circuits selected from the post decoding circuits PD₁-PD_{M}.

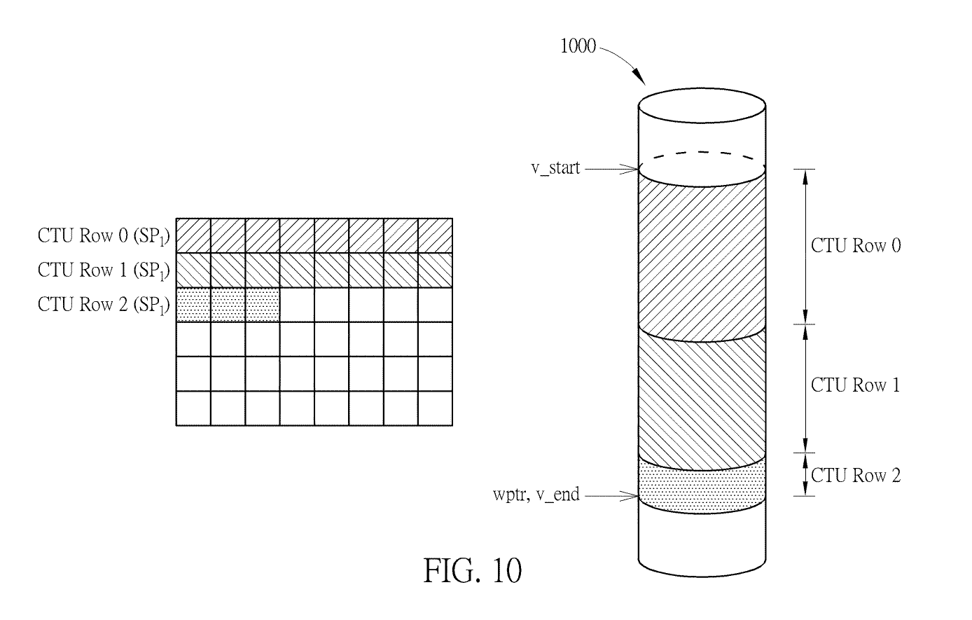

FIG. 10 is a diagram illustrating a first storage status of a ring buffer allocated in the UBE syntax data buffer 123 according to an embodiment of the present invention. In this example, the ring buffer 1000 is allocated in the UBE syntax data buffer 123 for the syntax parsing circuit SP₁, and has a top physical address v_start and a bottom physical address v_end. The ring buffer 1000 can be accessed (read/written) in a direction from the top physical address v_start to the bottom physical address v_end and then rolling back to the top physical address v_start. For brevity and simplicity, it is assumed that each coding block row may be one CTU row, the syntax parsing circuit SP₁ is an idle syntax parsing circuit that is repeatedly selected to perform syntax parsing of bitstream segments of consecutive CTU rows, and two post decoding circuits PD₁ and PD₂ are idle post decoders that are sequentially selected for post decoding UBE syntax data segments of the consecutive CTU rows. Initially, the syntax parsing circuit SP₁ is idle. Hence, the idle syntax parsing circuit SP₁ is selected to perform syntax parsing upon CTU Row 0. During the syntax parsing of CTU Row 0, the syntax parsing circuit SP₁ writes UBE syntax data into the ring buffer 1000, such that a write pointer wptr (which is indicative of a current write address of writing UBE syntax data into the ring buffer 1000 allocated in the UBE syntax data buffer 123) moves downwards. After the syntax parsing of CTU Row 0 is done, a corresponding UBE syntax data segment of CTU Row 0 is stored in the ring buffer 1000, and the syntax parsing circuit SP₁ enters an idle state. Since the syntax parsing circuit SP₁ is idle, it is selected to perform syntax parsing upon CTU Row 1. During the syntax parsing of CTU Row 1, the syntax parsing circuit SP₁ writes UBE syntax data into the ring buffer 1000, such that the write pointer wptr moves downwards. After the syntax parsing of CTU Row 1 is done, a corresponding UBE syntax data segment of CTU Row 1 is stored in the ring buffer 1000, and the syntax parsing circuit SP₁ enters an idle state. Since the syntax parsing circuit SP₁ is idle, it is selected to perform syntax parsing upon CTU Row 2. During the syntax parsing of CTU Row 2, the write pointer wptr reaches the bottom physical address v_end. At this moment, the ring buffer 1000 dedicated to the syntax parsing circuit SP₁ is full. Since the syntax parsing circuit SP₁ is unable to write any new UBE syntax data into the ring buffer 1000, the syntax parsing circuit SP₁ pauses the syntax parsing of CTU Row 2.

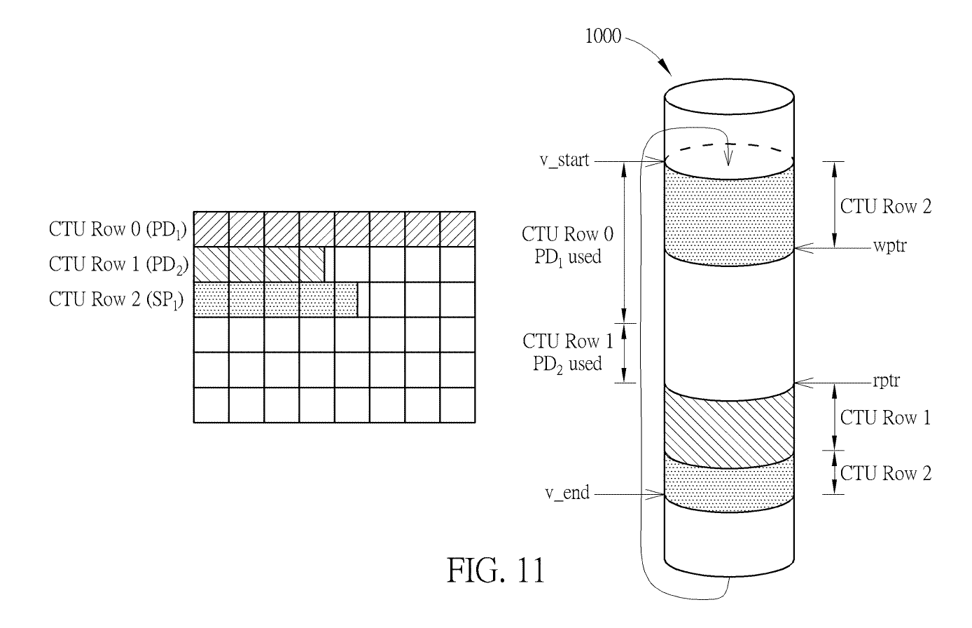

FIG. 11 is a diagram illustrating a second storage status of the ring buffer allocated in the UBE syntax data buffer 123 according to an embodiment of the present invention. Initially, the post decoding circuits PD₁ and PD₂ are idle. Hence, after the syntax parsing of CTU Row 0 is done, the idle post decoding circuits PD₁ is selected to perform post decoding upon CTU Row 0. During the post decoding of CTU Row 0, the post decoding circuit PD₁ reads UBE syntax data from the ring buffer 1000, such that a read pointer rptr (which is indicative of a current read address of reading UBE syntax data from the ring buffer 1000 allocated in the UBE syntax data buffer 123) moves downwards. Due to moving of the read pointer rptr, the ring buffer 1000 has a storage space available for storing new UBE data of CTU Row 2 by overwriting the post-decoded UBE data of CTU Row 0. Hence, the syntax parsing circuit SP₁ resumes the syntax parsing of CTU Row 2, and the write pointer wptr rolls back to the top physical address v_start to continue writing UBE data of CTU Row 2 into the ring buffer 1000. In addition, the idle post decoding circuits PD₂ is selected to perform post decoding upon CTU Row 1. Hence, a read pointer rptr keeps moving downwards due to post decoding of CTU Row 1. It should be noted that, if the post decoding of UBE data continues after the read pointer rptr reaches the bottom physical address v_end, the read pointer rptr will roll back to the top physical address v_start to continue read UBE data from the ring buffer 1000.

Due to inherent characteristics of a ring buffer (e.g., a ring buffer allocated for each of the syntax parsing circuits SP₁-SP_{N}), the write pointer wptr chases the read pointer rptr, and the read pointer rptr also chases the write pointer wptr. A racing mode between the read pointer rptr and the write pointer wptr may be employed to control access (read/write) of the ring buffer (e.g., the ring buffer allocated for each of the syntax parsing circuits SP₁-SP_{N}). For example, the syntax data buffer 123 has a plurality of ring buffers BF₁-BF_{N} allocated therein, and each of the syntax parsing circuits SP₁-SP_{N} writes a UBE syntax data output into a corresponding ring buffer that may be read by one or more post decoding circuits selected from the post decoding circuits PD₁-PD_{M}. With regard to the example shown in FIGS. 10-11, the syntax parsing circuit SP₁ writes UBE syntax data segments into the ring buffer 100, and multiple post decoding circuits PD₁ and PD₂ are selected to read UBE syntax data segments from the ring buffer 100 for post decoding.

In a case where a ring buffer (e.g., BFₙ, where 1≦n≦N) allocated for one syntax parsing circuit (e.g., SPₙ, where 1≦n≦N) is read by only one selected post decoding circuit (e.g., PDₘ, where 1≦m≦M), the write pointer wptr of the syntax parsing circuit SPₙ is updated to the post decoding circuit PDₘ to act as the actual write pointer wptr used by the racing-mode ring buffer access control scheme, and the read pointer rptr used by the post decoding circuit PDₘ is updated to the syntax parsing circuit SPₙ to act as the actual read pointer rptr used by the racing-mode ring buffer access control scheme. Regarding the post decoding circuit PDₘ, it compares its read pointer rptr with the received write pointer wptr. When the read pointer rptr catches up the write pointer wptr (e.g., wptr=rptr), the post decoding circuit PDₘ stops reading data of a UBE syntax data segment from the ring buffer. In this way, the racing-mode ring buffer access control scheme prevents the post decoding circuit PDₘ from retrieving wrong UBE syntax data from the ring buffer BFₙ. Regarding the syntax parsing circuit SPₙ, it compares its write pointer wptr with the received read pointer rptr. When a distance between the write pointer wptr and the read pointer rptr reaches a threshold (e.g., wptr==rptr-1), the syntax parsing circuit SPₙ stops writing data of a UBE syntax data segment into the ring buffer BFₙ. In this way, the racing-mode ring buffer access control scheme prevents the syntax parsing circuit SPₙ from overwriting UBE syntax data that is not post decoded yet.

In another case where a ring buffer (e.g., BFₙ, where 1≦n≦N) allocated for one syntax parsing circuit (e.g., SPₙ, where 1≦n≦N) is read by multiple selected post decoding circuits (e.g., PDₘ and PDₛ, where 1≦s≦M, 1≦s≦M, and m≠s), the write pointer wptr of the syntax parsing circuit SPₙ is updated to each of the post decoding circuits PDₘ and PDₛ to act as the actual write pointer wptr used by the racing-mode ring buffer access control scheme, and one of the read pointers rptr of the post decoding circuits PDₘ and PDₛ is updated to the syntax parsing circuit SPₙ to act as the actual read pointer rptr used by the racing-mode ring buffer access control scheme. For example, among read pointers of multiple post decoding circuits currently selected to read data from a ring buffer, a read pointer associated with reading of a UBE syntax data segment of a coding block row with a smallest row index value is updated to a syntax parsing circuit that writes data into the ring buffer. Suppose that the post decoding circuits PDₘ is selected to process a UBE syntax data segment of a first coding block row (e.g., CTU Row 0) of a video frame, the post decoding circuits PDₛ is selected to process a UBE syntax data segment of a second coding block row (e.g., CTU Row 2) of the same video frame, and a row index value of the first coding block row is smaller than a row index value of the second coding block row. The read pointer rptr of the post decoding circuit PDₘ is updated to the syntax parsing circuit SPₙ to act as the actual read pointer rptr used by the racing-mode ring buffer access control scheme.

Regarding each of the post decoding circuits PDₘ and PDₛ, it compares its read pointer rptr with the received write pointer wptr. When the read pointer rptr catches up the write pointer wptr (e.g., wptr=rptr), the post decoding circuit PDₘ/PDₛ stops reading data of a UBE syntax data segment from the ring buffer. In this way, the racing-mode ring buffer access control scheme prevents the post decoding circuit PDₘ/PDₛ from retrieving wrong UBE syntax data from the ring buffer BFₙ. Regarding the syntax parsing circuit SPₙ, it compares its write pointer wptr with the received read pointer rptr. When a distance between the write pointer wptr and the read pointer rptr reaches a threshold (e.g., wptr==rptr-1), the syntax parsing circuit SPₙ stops writing data of a UBE syntax data segment into the ring buffer BFₙ. In this way, the racing-mode ring buffer access control scheme prevents the syntax parsing circuit SPₙ from overwriting UBE syntax data that is not post decoded yet.

When a video source is in an ultra-high resolution, an amount of video bitstream data generated from A/V demultiplexing of an input bitstream of one video frame may also be large. Using the bitstream buffer 121 to fully accommodate all video bitstream data of a video frame with an ultra-high resolution requires a large buffer size inevitably. To reduce the storage space usage, the present invention further proposes using a ring buffer to implement the bitstream buffer 121 accessed by the A/V demultiplexing circuit 104 and the syntax parsing circuits SP₁-SP_{N}. Similarly, a racing mode between a read pointer rptr and a write pointer wptr may be employed to control access (read/write) of the bitstream buffer 121. In this example, a write pointer wptr of A/V demultiplexing circuit 104 is updated to each of syntax parsing circuits SP₁-SP_{N} to act as the actual write pointer wptr used by the racing-mode ring buffer access control scheme, and one of the read pointers rptr of the syntax parsing circuits SP₁-SP_{N} is updated to the A/V demultiplexing circuit 104 to act as the actual read pointer rptr used by the racing-mode ring buffer access control scheme. For example, among read pointers of multiple syntax parsing circuits that are currently active to read data from the bitstream buffer 121 being a ring buffer, a read pointer associated with reading of a bitstream segment of a coding block row with a smallest row index value is updated to the A/V demultiplexing circuit 104. Regarding each of the syntax parsing circuits SP₁-SP_{N}, it compares its read pointer rptr with the received write pointer wptr. When the read pointer rptr catches up the write pointer wptr (i.e., wptr=rptr), the syntax parsing circuit stops reading data of a bitstream segment from the bitstream buffer 121. In this way, the racing-mode ring buffer access control scheme prevents the syntax parsing circuit from retrieving wrong video bitstream data from the bitstream buffer 121. Regarding the A/V demultiplexing circuit 104, it compares its write pointer wptr with the received read pointer rptr. When a distance between the write pointer wptr and the read pointer rptr reaches a threshold (e.g., wptr==rptr-1), the A/V demultiplexing circuit 104 stops writing the video bitstream data into the bitstream buffer 121. In this way, the racing-mode ring buffer access control scheme prevents the A/V demultiplexing circuit 104 from overwriting video bitstream data that is not syntax parsed yet.

In the embodiment shown in FIG. 1, the syntax parser 106 of the two-phase syntax parsing scheme has multiple syntax parsing circuits SP₁-SP_{N} implemented therein, and the post decoder 108 of the two-phase syntax parsing scheme has multiple post decoding circuits PD₁-PD_{M} implemented therein. However, this is for illustrative purposes only, and is not meant to be a limitation of the present invention. In a first alternative design, the syntax parser 106 of the two-phase syntax parsing scheme may be modified to have a single syntax parsing circuit SP₁ only, and the post decoder 108 of the two-phase syntax parsing scheme still has multiple post decoding circuits PD₁-PD_{M} implemented therein. In a second alternative design, the syntax parser 106 of the two-phase syntax parsing scheme still has multiple syntax parsing circuits SP₁-SP_{N} implemented therein, and the post decoder 108 of the two-phase syntax parsing scheme may be modified to have a single post decoding circuit PD₁ only. These alternative designs all fall within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video processing system comprising:
a storage device, comprising:
a first buffer; and
a second buffer;
a demultiplexing circuit, arranged to receive an input bitstream, and perform a demultiplexing operation upon the input bitstream to write a video bitstream into the first buffer and write a plurality of start points of a plurality of bitstream segments of the video bitstream stored in the first buffer into the second buffer, wherein each start point is indicative of a start address of a corresponding bitstream segment stored in the first buffer; and
a syntax parser, comprising:
a plurality of syntax parsing circuits; and
a syntax parsing control circuit, arranged to fetch a first start point from the second buffer, assign the fetched first start point to a first syntax parsing circuit that is an idle syntax parsing circuit selected from the syntax parsing circuits, and trigger the selected first syntax parsing circuit to start syntax parsing of a first bitstream segment that is read from the first buffer according to the fetched first start point.

2. The video processing system of claim 1, wherein the syntax parsing control circuit is further arranged to fetch a second start point from the second buffer, assign the fetched second start point to a second syntax parsing circuit that is an idle syntax parsing circuit selected from the syntax parsing circuits, and trigger the selected second syntax parsing circuit to start syntax parsing of a second bitstream segment that is read from the first buffer according to the fetched second start point; and a processing time of the syntax parsing of the first bitstream segment overlaps a processing time of the syntax parsing of the second bitstream segment.

3. The video processing system of claim 2, wherein the first bitstream segment contains encoded data of a first coding block row of a frame, and the second bitstream segment contains encoded data of a second coding block row of the same frame.

4. The video processing system of claim 2, wherein the syntax parsing control circuit is further arranged to monitor the syntax parsing of the first bitstream segment and the syntax parsing of the second bitstream segment, and stall the syntax parsing of the second bitstream segment when a spatial neighbor data needed by the syntax parsing of the second bitstream segment is not derived from the syntax parsing of the first bitstream segment yet.

5. The video processing system of claim 1, wherein the first buffer is a ring buffer; the demultiplexing circuit is further arranged to update a write pointer to each of the syntax parsing circuits, where the write pointer is indicative of a current write address of writing data of the video bitstream into the first buffer; and the first syntax parsing circuit is further arranged to stop the start syntax parsing of the first bitstream segment when a read pointer used by the first syntax parsing circuit catches up the write pointer, where the read pointer is indicative of a current read address of reading data of the first bitstream segment from the first buffer.

6. The video processing system of claim 1, wherein the first buffer is a ring buffer; the first syntax parsing circuit is further arranged to update a read pointer to the demultiplexing circuit, where the read pointer is indicative of a current read address of reading data of the first bitstream segment from the first buffer; and the demultiplexing circuit is further arranged to stop writing the video bitstream into the first buffer when a distance between a write pointer used by the demultiplexing circuit and the read pointer reaches a threshold, where the write pointer is indicative of a current write address of writing data of the video bitstream into the first buffer.

7. The video processing system of claim 1, wherein the storage device further comprises:
a third buffer, arranged to store a plurality of universal binary entropy (UBE) syntax data segments output from the syntax parser for the bitstream segments, respectively, wherein each of the bitstream segments contains arithmetic-encoded syntax data, and each of the UBE syntax data segments contains no arithmetic-encoded syntax data;
the video processing system further comprises:
a post decoder, comprising:
a plurality of post decoding circuits, each comprising an UBE syntax decoder arranged to perform UBE syntax decoding upon one UBE syntax data segment read from the third buffer to output decoded syntax data; and
a post decoding control circuit, arranged to assign a first UBE start point to a first post decoding circuit that is an idle post decoding circuit selected from the post decoding circuits, and trigger the selected first post decoding circuit to start post decoding of a first UBE syntax data segment that is read from the third buffer according to the first UBE start point, wherein the first UBE start point is indicative of a start address of the first UBE syntax data segment stored in the third buffer.

8. The video processing system of claim 7, wherein the post decoding control circuit is further arranged to assign a second UBE start point to a second post decoding circuit that is an idle post decoding circuit selected from the post decoding circuits, and trigger the selected second post decoding circuit to start post decoding of a second UBE syntax data segment that is read from the third buffer according to the second UBE start point, where the second UBE start point is indicative of a start address of the second UBE syntax data segment stored in the third buffer; and a processing time of the post decoding of the first UBE syntax data segment overlaps a processing time of the post decoding of the second UBE syntax data segment.

9. The video processing system of claim 8, wherein the first UBE syntax data segment contains UBE syntax data of a first coding block row of a frame, and the second UBE syntax data segment contains UBE syntax data of a second coding block row of the same frame.

10. The video processing system of claim 8, wherein the post decoding control circuit is further arranged to monitor the post decoding of the first UBE syntax data segment and the post decoding of the second UBE syntax data segment, and stall the post decoding of the second UBE syntax data segment when a spatial neighbor data needed by the post decoding of the second UBE syntax data segment is not derived from the post decoding of the first UBE syntax data segment yet.

11. The video processing system of claim 7, wherein the post decoding control circuit comprises a counter arranged to update a count value in response to one notification signal generated from the syntax parsing control circuit each time syntax parsing of one bitstream segment is completed; and the post decoding control circuit refers to the count value maintained by the counter to assign the first UBE start point to the first post decoding circuit and trigger the selected first post decoding circuit.

12. The video processing system of claim 7, wherein the third buffer comprises a plurality of ring buffers allocated for storing the UBE syntax data segments generated from the syntax parsing circuits, respectively; the first syntax parsing circuit is further arranged to update a write pointer to the first post decoding circuit; when a read pointer catches up the write pointer, the first post decoding circuit is further arranged to stop reading data of the first UBE syntax data segment from a ring buffer that stores the first UBE syntax data segment generated by the first syntax parsing circuit, where the read pointer is indicative of a current read address of reading UBE syntax data from the ring buffer, and the write pointer is indicative of a current write address of writing UBE syntax data into the ring buffer.

13. The video processing system of claim 7, wherein the third buffer comprises a plurality of ring buffers allocated for storing the UBE syntax data segments generated from the syntax parsing circuits, respectively; the first post decoding circuit is further arranged to update a read pointer to the first syntax parsing circuit; when a distance between a write pointer and the read pointer reaches a threshold, the first syntax parsing circuit is further arranged to stop writing data of the first UBE syntax data segment into a ring buffer, where the read pointer is indicative of a current read address of reading UBE syntax data from the ring buffer, and the write pointer is indicative of a current write address of writing UBE syntax data into the ring buffer.

14. The video processing system of claim 7, wherein the storage device further comprises:
a fourth buffer, arranged to store a plurality of reconstructed frame segments output from the post decoder for the UBE syntax data segments, respectively; and
the video processing system further comprises:
a display control circuit, comprising a counter arranged to update a count value in response to one notification signal generated from the post decoding control circuit each time post decoding of one UBE syntax data segment is completed; and the display control circuit is arranged to refer to the count value to assign a start address of a reconstructed frame stored in the fourth buffer to a display engine and trigger the display engine to start displaying of the reconstructed frame.

15. A video processing system comprising:
a storage device, comprising:
a first buffer; and
a second buffer;
a demultiplexing circuit, arranged to receive an input bitstream, and perform a demultiplexing operation upon the input bitstream to write a video bitstream into the first buffer;
a syntax parser, arranged to perform syntax parsing upon a plurality of bitstream segments of the video bitstream to generate a plurality of universal binary entropy (UBE) syntax data segments, respectively, and write the UBE syntax data segments into the second buffer, wherein each of the bitstream segments contains arithmetic-encoded syntax data, and each of the UBE syntax data segments contains no arithmetic-encoded syntax data; and
a post decoder, comprising:
a plurality of post decoding circuits, each comprising an UBE syntax decoder arranged to perform UBE syntax decoding upon one UBE syntax data segment read from the second buffer to output decoded syntax data; and
a post decoding control circuit, arranged to assign a first UBE start point to a first post decoding circuit that is an idle post decoding circuit selected from the post decoding circuits, and trigger the selected first post decoding circuit to start post decoding of a first UBE syntax data segment that is read from the second buffer according to the first UBE start point, wherein the first UBE start point is indicative of a start address of the first UBE syntax data segment stored in the second buffer.

16. The video processing system of claim 15, wherein the post decoding control circuit is further arranged to assign a second UBE start point to a second post decoding circuit that is an idle post decoding circuit selected from the post decoding circuits, and trigger the selected second post decoding circuit to start post decoding of a second UBE syntax data segment that is read from the second buffer according to the second UBE start point, where the second UBE start point is indicative of a start address of the second UBE syntax data segment stored in the second buffer; and a processing time of the post decoding of the first UBE syntax data segment overlaps a processing time of the post decoding of the second UBE syntax data segment.

17. The video processing system of claim 16, wherein the first UBE syntax data segment contains UBE syntax data of a first coding block row of a frame, and the second UBE syntax data segment contains UBE syntax data of a second coding block row of the same frame.

18. The video processing system of claim 16, wherein the post decoding control circuit is further arranged to monitor the post decoding of the first UBE syntax data segment and the post decoding of the second UBE syntax data segment, and stall the post decoding of the second UBE syntax data segment when a spatial neighbor data needed by the post decoding of the second UBE syntax data segment is not derived from the post decoding of the first UBE syntax data segment yet.

19. The video processing system of claim 15, wherein the post decoding control circuit comprises a counter arranged to update a count value in response to one notification signal generated from the syntax parser each time syntax parsing of one bitstream segment is completed; and the post decoding control circuit refers to the count value to assign the first UBE start point to the first post decoding circuit and trigger the selected first post decoding circuit.

20. The video processing system of claim 15, wherein the storage device further comprises:
a third buffer, arranged to store a plurality of reconstructed frame segments output from the post decoder for the UBE syntax data segments, respectively; and
the video processing system further comprises:
a display control circuit, comprising a counter arranged to update a count value in response to one notification signal generated from the post decoding control circuit each time post decoding of one UBE syntax data segment is completed; and the display control circuit is arranged to refer to the count value to assign a start address of a reconstructed frame stored in the fourth buffer to a display engine and trigger the display engine to start displaying of the reconstructed frame.
